(19) United States
(12) Patent Application Publication
(10) Pub. No.: US 2016/0232720 A1
(43) Pub. Date: Aug. 11, 2016

(54) System and method for parking space management

(71) Applicant: Barking OÜ, Tallinn (EE)

(72) Inventors: Meelis Haidak, Koo vald (EE); Ott Reinhold, Tallin (EE); Kustas Kõiv, Saku (EE); Kristjan Hiiemaa, Tallinn (EE)

(21) Appl. No.: 15/014,039

(22) Filed: Feb. 3, 2016

Related U.S. Application Data
(60) Provisional application No. 62/111,181, filed on Feb. 3, 2015.

(51) Int. Cl. G07B 15/02

(52) U.S. Cl. CPC G07B 15/02

(57) ABSTRACT

A system and a method for parking space management are disclosed. The invention provides a secure and easy to use solution for parking space owners whose parking spaces are located in closed parking areas or in open access parking areas. The system and method enables the parking space owners to earn money for renting out their parking spaces during the time when the parking space is not occupied. On the other hand the system and method enables the drivers to find closest, cheapest, most convenient parking spots easily.

### PRIORITY

This application claims priority of US provisional application No. 62/111,181 filed on Feb. 3, 2015, and the content of which are incorporated herein by reference.

### FIELD OF THE INVENTION

The present invention relates to parking management solutions, more specifically parking space management systems and methods in closed parking areas with restricted entrance and exit.

### BACKGROUND OF THE INVENTION

Despite the high parking fees in urban areas, it is complicated to find free parking space. At the same time there are lots of unoccupied and free parking spaces but the access to these parking spaces is restricted to public use because these parking spaces are for personal use. These type of parking spaces are in use and occupied for example during the afterhours and unoccupied during the working hours if the parking space belongs to private person or if the parking space belongs to the company, then it's in use during the working hours and free and unoccupied during the afterhours, weekends and holidays.

For third parties these types of parking spaces are inaccessible because the access to the parking space is restricted by closed gates, barriers, boom gates, chains, etc.

Although there are several known solutions for parking space management the known solutions do not allow parking in closed areas where the entrance and exit is equipped with gates, barriers, boom gates, doors or other devices that restrict the access to and from the parking area.

### BRIEF DESCRIPTION OF THE INVENTION

The aim of the present invention, system and method for parking space management, is to provide a secure and easy to use solution for parking space owners whose parking spaces are located in closed parking areas (for example toll parking areas, residential areas, airports, public transport stations, shopping centers, office buildings, hospitals, hotels and other institutions with restricted parking areas) or open access parking areas and earn money for renting out their parking spaces during the time when the parking space is not occupied.

In contrast with known solutions the present system and method for parking space management enables parking space owners to manage the parking spaces in closed parking areas where the entrance and exit is restricted with closed gates, barriers, doors or other means to restrict unauthorized entrance or exit to or from the parking area and to rent out their parking spaces during the time when the parking spaces are not in use and earn money. For drivers the present system and method help to find cheapest and nearest parking space on closed parking areas and save money and time for looking for parking spaces. For the owners of parking areas the system and method help to organize the parking arrangements. Such areas are for example private driveways and courtyards where space that are vacant during the day-time while the owner is at work or school; parking facilities, where the parking spaces are available during evenings when commercial hours are over and the demand is lower; hotels, which have during the low seasons lots of vacancies. The aim of the present invention is achieved by the system comprising owner module and driver module installed into communication device, which is connected via internet to the parking management module, parking controller connected to the automatics of the parking gate, barrier, door, etc. and controller activating device to activate the parking controller and to communicate with the parking management module.

To enable for parking space owner to rent out the parking space the parking controller is installed closed to the gate or barrier and connected with the device that opens and closes the gate, barrier, boom gate or other device that restricts the access to and from the parking area.

The communication device (e.g. smart phone, tablet, laptop, PC) is used to manage the renting of parking space. The parking space owner adds the parking information to the parking management module via the communication device.

The parking information comprises the location of the parking area, date and times when the parking space is available, the parking cost, the parking terms, the description and location of the parking space in parking area and other instructions.

Parking payments are arranged via mobile payments, credit card payments, internet bank payments or other type of electronic payments.

The present parking management system and method enables to rent out parking spaces in restricted areas but also parking spaces in open areas (streets and any other public places).

### BRIEF DESCRIPTION OF THE DRAWINGS

The preferred embodiment of present invention is explained more precisely with references to figures added, where

FIG. 1 illustrates the system according to the present invention;

FIG. 2 illustrates the method according to the present invention;

FIG. 3 illustrates the operations according to the present method implemented in the present system.

### DETAILED DESCRIPTION OF THE INVENTION

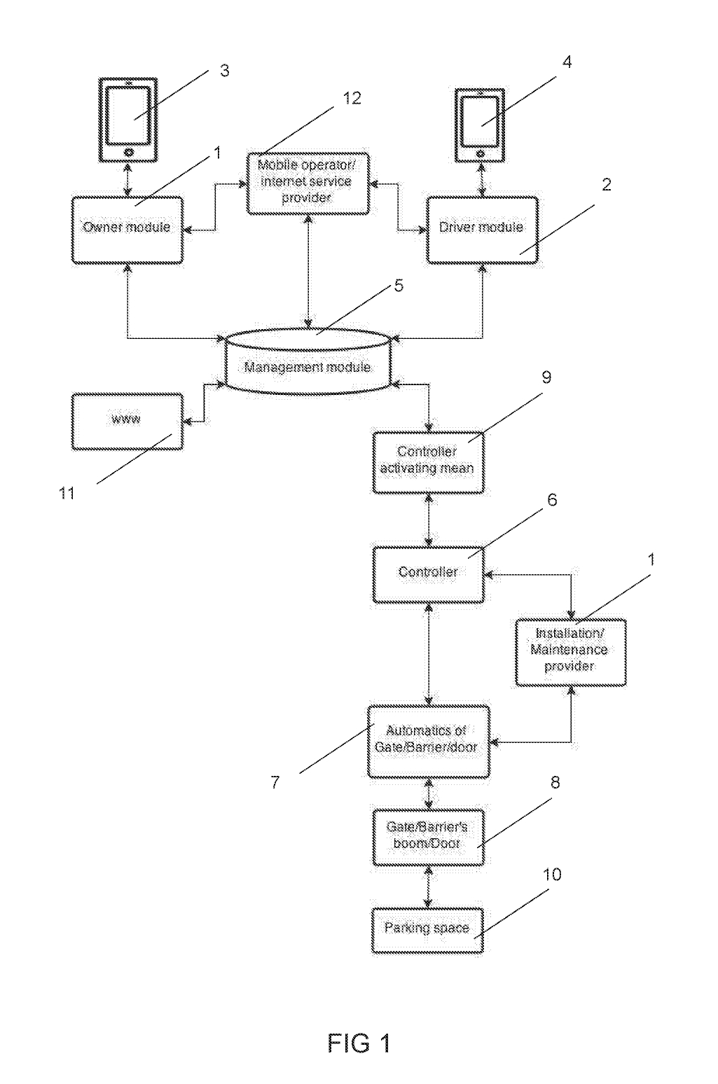

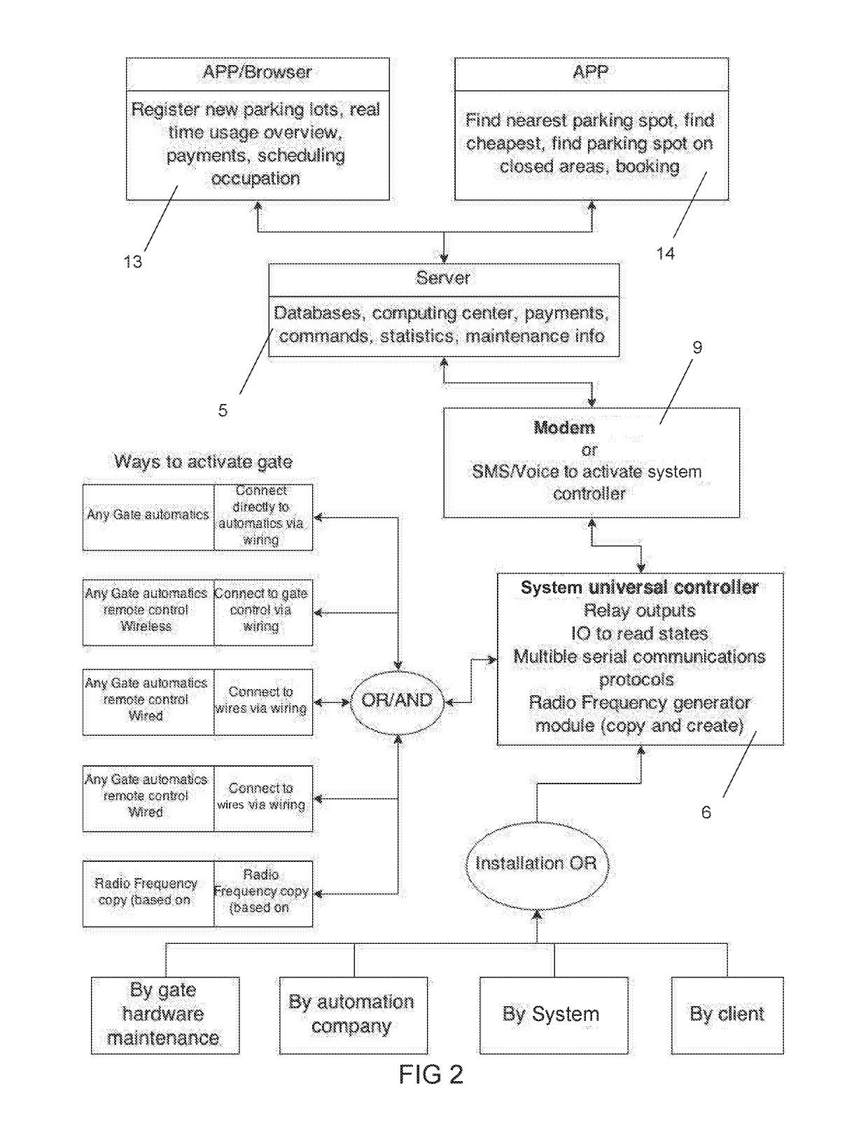

The system for parking space management according to present invention shown of FIG. 1 and FIG. 2 comprises owner module 1 and driver module 2 installed into corresponding owner's communication device 3 and driver's communication device 4, parking management module 5 located in the server, wherein the communication devices 3 and 4 and parking management module 5 are connected via internet, at least one parking controller 6 connected and synchronized with the automatics 7 of the parking gate, barrier, door, etc. 8 at parking area 10, at least one controller activating device 9 (for example modem, sms or voice message device) to activate corresponding parking controller 9 and to communicate with the parking management module 5 and web based electronic service module 11 for the parking space owner connected to the management module, whereby the system is connected via management module 5, owner module 1, and driver module 2 with the mobile operator and/or internet service provider 12.

The communication device 3 and 4 is for example smart phone, tablet, laptop, PC, smartwatch, smart glasses. The communication device using the driver module 2 or owner module 1 provides for the driver or the parking space owner information regarding the parking spaces at parking area 10, information regarding the bookings, free parking spaces and free parking times, payments, shows the parking history, shows the renting history, etc.

The owner module 1, which is installed into the owner's communication device 3, and web based electronic service module 11 comprises application 13 for registering new parking spaces, monitoring real time usage overview, payments, scheduling occupation.

The driver module 2, which is installed into the driver's communication device 4, comprises application 14 for finding nearest parking space, finding cheapest parking space, finding parking spaces on closed areas, booking the parking space and paying for the parking space. The driver module 2 communicates with the controller 6 and enables to open the closed gates, barrier booms, doors 8 of the parking areas 10.

The parking management module 5 comprises multiple databases of parking areas 10, parking space owners, registered drivers and parking space users; computing center; payment system; commands; statistics; maintenance information.

The parking controller 6 comprises relay outputs, IO to read states, multiple serial communication protocols, radio frequency generator module. The parking controller 6 synchronizes parking management module 5 with gate, barrier or door automatics 7. Once the parking controller 6 is synchronized with the existing automatics 7 the user (parking space owner or driver who is looking for parking space) has the power to open gates/doors 8 via communication device 3 or 4 (e.g. smartphone, tablet, etc.). The examples of the ways to open the gate, doors or barriers are shown of FIG. 2.

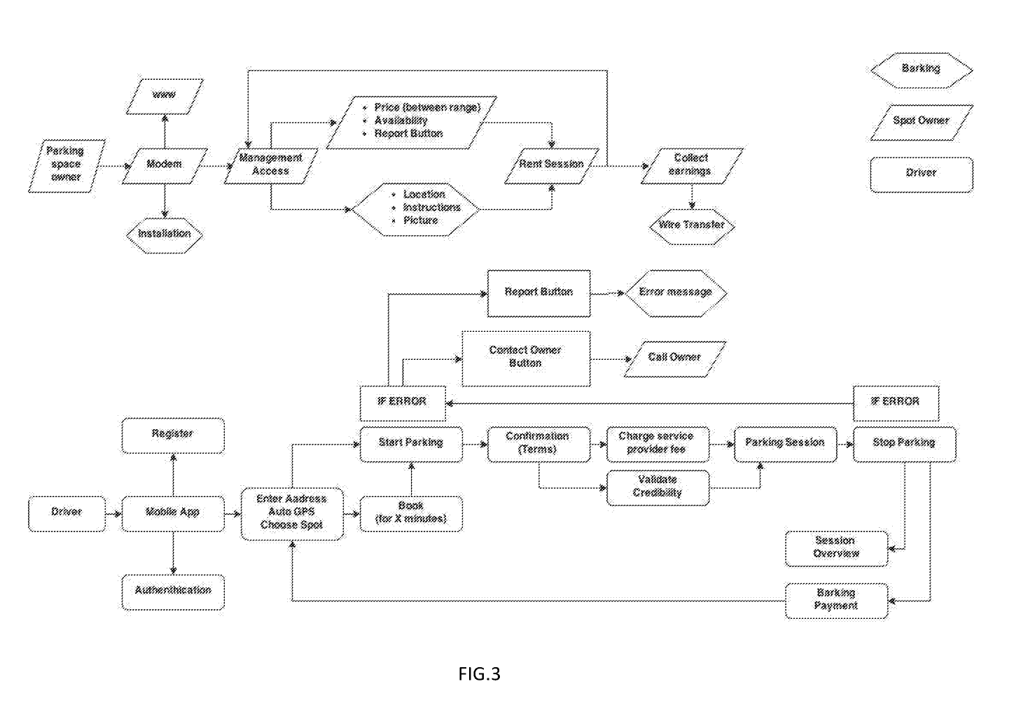

The figure FIG. 3 illustrates the operations according to the present method implemented in the present system, wherein it is shown one of the possible embodiments of the present invention.

The method for parking space management comprises following steps:
installing the parking controller into the gate, barrier, door automatics of the parking area entrance and/or exit;
installing the controller activating device to the parking area and synchronizing the controller activating device with the parking controller;
synchronizing the controller activating device with the parking management module by adding and registering the information regarding the parking area, parking space and parking space owner;
connecting the parking management module with the owner module by the communication device;
receiving the parking information from the owner module via the communication device;
making the received parking information available for the driver module;
initiating the parking process by receiving the parking request from the driver module via the communication device;
opening the gate, barrier, boom, door etc. of the entrance of closed parking area;
activating the parking process;
receiving the payment;
ending the parking process;
sending the received payment to the user account of the parking space owner.

What is claimed is:

1. A system for parking space management comprising an owner module and a driver module installed into a communication device, a parking management module, wherein the communication device and parking management module are connected via internet, at least one parking controller connected and synchronized with automatics of a parking gate, barrier, door, etc, at least one controller activating device (for example modem, sms or voice message device) to activate corresponding parking controller and to communicate with the parking management module, a web based electronic service module connected to the management module, whereby the system is connected via management module, owner module and driver module with the mobile operator and/or internet service provider.

2. The system according to claim 1, wherein the owner module comprises application for registering new parking spaces, monitoring real time usage overview, payments, scheduling occupation.

3. The system according to claim 1, wherein the driver module comprises application for finding nearest parking space, finding cheapest parking space, finding parking spaces on closed areas, booking the parking space and paying for the parking space.

4. The system according to claim 1, wherein the parking management module comprises multiple databases of parking areas, parking space owners, registered drivers and parking space users; computing center; payment system; commands; statistics; maintenance information.

5. The system according to claim 1, wherein the controller activating device is modem, sms or voice message device.

6. The system according to claim 1, wherein the parking controller comprises relay outputs, IO to read states, multiple serial communication protocols, radio frequency generator module.

7. A method for parking space management comprising the following steps:
installing a parking controller into a gate, barrier, door automatics of a parking area entrance and/or exit;
installing a controller activating device to the parking area and synchronizing the controller activating device with the parking controller;
synchronizing the controller activating device with a parking management module by adding and registering information regarding the parking area, parking space and parking space owner;
connecting the parking management module with an owner module by a communication device;
receiving the parking information from the owner module via the communication device;
making the received parking information available for a driver module;
initiating a parking process by receiving a parking request from the driver module via the communication device;
opening the gate, barrier, boom, door etc. of entrance of closed parking area;
activating the parking process;
receiving a payment;
ending the parking process;
sending the received payment to a user account of parking space owner.
